(19) United States
(12) Patent Application Publication
(10) Pub. No.: US 2018/0257613 A1
(43) Pub. Date: Sep. 13, 2018

(54) NON-HYDRAULIC FEEDBACK SYSTEM FOR VEHICLE HAVING A SIMULATED BRAKE PEDAL

(71) Applicant: GM GLOBAL TECHNOLOGY OPERATIONS LLC, Detroit, MI (US)

(72) Inventors: Marsella L. White, Milford, MI (US); Michael G. Petrucci, Milford, MI (US); Anthony J. Rifici, Milford, MI (US); Brian W. Quinn, Warren, MI (US); Steven J. Weber, Warren, MI (US); William K. Wise, Milford, MI (US)

(21) Appl. No.: 15/758,225

(22) PCT Filed: Sep. 9, 2016
(86) PCT No.: PCT/US2016/050981

§ 371 Date: Mar. 7, 2018

Related U.S. Application Data
(60) Provisional application No. 62/217,848, filed on Sep. 12, 2015.

(51) Int. Cl. B60T 7/04; B60T 8/171; B60T 13/58; B60T 13/66

(52) U.S. Cl. CPC B60T 7/042; B60T 8/171; B60T 13/588; B60T 13/662; B60T 13/586

(57) ABSTRACT

A vehicle includes a chassis, a power system supported by the chassis, and a plurality of wheels supported by the chassis. At least one of the plurality of wheels is operatively connected to the power system. A plurality of brakes is operatively associated with corresponding ones of the plurality of wheels, and a simulated brake pedal is operatively associated with the plurality of brakes. The simulated brake pedal is hydraulically isolated from the plurality of brakes. A non-hydraulic braking feedback controller is operatively connected to the plurality of brakes and the simulated brake pedal. The non-hydraulic braking feedback controller selectively provides at least one of a tactile, an audible, and a visual feedback to a driver based on an activation of the simulated brake pedal.

### CROSS-REFERENCE TO RELATED APPLICATIONS

This application claims priority to U.S. Provisional Application No. 62/217,848, which was filed on Sep. 12, 2015. The entire contents of U.S. Provisional Application No. 62/217,848 are incorporated herein by reference.

### FIELD OF THE INVENTION

The subject invention relates to the art of motor vehicles and, more particularly, to a non-hydraulic feedback system for a vehicle having a simulated brake pedal.

### BACKGROUND

Motor vehicles typically include one or more wheels each having an associated brake. The brake is selectively activated to slow a momentum of the motor vehicle. Conventionally, a driver applies a force to depress a brake pedal that is mechanically linked to a hydraulic pump or master cylinder. The hydraulic pump amplifies the force applied by the driver to deliver a hydraulic fluid to a brake cylinder. The brake cylinder acts upon one or more brake pads or shoes. The brake pads are forced against a braking member, such as a disc or a drum that is associated with each wheel. As such, conventional brake systems provide a mechanical/hydraulic feedback to the driver through the brake pedal. Based on the feedback, the driver may determine that additional force is required, or that brake maintenance may be desirable.

Certain motor vehicles may include a simulated brake pedal in which there is no direct mechanical and/or hydraulic link to a brake actuator. Simulated brake pedals may activate a switch or motor that urges brake pads against braking surfaces. Accordingly, simulated brake pedals provide no feedback to a driver regarding brake operation. As such, drivers may be uncomfortable with vehicles having a simulated brake pedal. Further, without feedback, a driver may wait too long before initiating brake maintenance. Accordingly, it is desirable to provide systems for providing a non-hydraulic feedback to a vehicle having a simulated brake pedal.

### SUMMARY OF THE INVENTION

In one exemplary embodiment, a vehicle includes a chassis, a power system supported by the chassis, and a plurality of wheels supported by the chassis. At least one of the plurality of wheels is operatively connected to the power system. A plurality of brakes is operatively associated with corresponding ones of the plurality of wheels, and a simulated brake pedal is operatively associated with the plurality of brakes. The simulated brake pedal is hydraulically isolated from the plurality of brakes. A non-hydraulic braking feedback controller is operatively connected to the plurality of brakes and the simulated brake pedal. The non-hydraulic braking feedback controller selectively provides at least one of a tactile, an audible, and a visual feedback to a driver based on an activation of the simulated brake pedal.

In accordance with another exemplary embodiment, a method of providing at least one of a tactile and an audible feedback to a driver of a vehicle having a simulated brake pedal includes detecting an activation of the simulated brake pedal, determining an activation type, and outputting one of a tactile feedback though the simulated brake pedal, an audible feedback, and a visual feedback based on the activation type.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a top schematic view of a vehicle having a simulated brake pedal and a non-hydraulic braking feedback controller, in accordance with an exemplary embodiment;

FIG. 2 is a block diagram illustrating a non-hydraulic braking feedback controller, in accordance with an exemplary embodiment; and

FIG. 3 is a flow chart illustrating a method of providing non-hydraulic feedback to a driver through a simulated brake pedal, in accordance with an aspect of an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

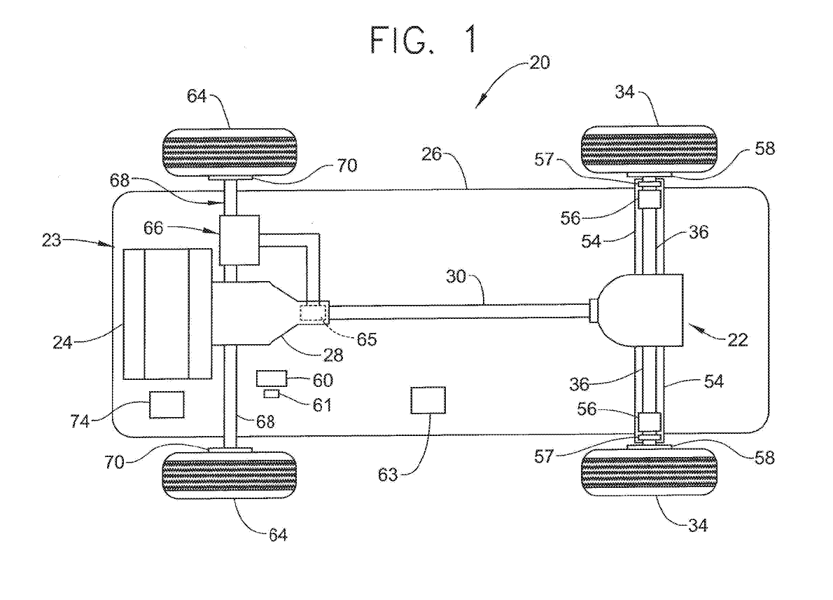

In accordance with an exemplary embodiment of the invention, FIG. 1 illustrates a vehicle 20 having a differential assembly 22. Differential assembly 22 may sometimes be referred to as a rear drive module. It should be appreciated that the vehicle 20 may be an automobile, truck, van or sport utility vehicle for example. As used herein, the term “vehicle” is not limited to just an automobile, truck, van or sport utility vehicle, but may also include any self-propelled or towed conveyance suitable for transporting a burden. Vehicle 20 may include a power system 23 shown in the form of an engine 24, such as a gasoline or diesel fueled internal combustion engine for example. Engine 24 may further be a hybrid type engine that combines an internal combustion engine with an electric motor for example. Power system 23 may also take the form of an electric motor. At this point, it should be understood that the exemplary embodiments are not limited to the vehicle shown and may be incorporated into any type of vehicle including trucks, sport utility vehicles (SUVs), off road vehicles, comfort vehicles, and the like.

Engine 24 and differential assembly 22 are coupled to a frame or other chassis structure 26. Engine 24 is coupled to differential assembly 22 by a transmission 28 and a driveshaft 30. Transmission 28 may be configured to reduce the rotational velocity and increase the torque of the engine 24 output. This modified output is then transmitted to differential assembly 22 via driveshaft 30. Differential assembly 22 transmits the output torque from the driveshaft 30 through a differential gear set (not shown) to a pair of driven wheels, e.g., rear wheels 34 via axles 36.

In one embodiment, each axle 36 extends through an axle tube 54. The axle tube 54 includes a hollow interior (not separately labeled) that extends a length thereof. At one end of the axle tube 54 a bearing 56 is mounted to support an end (also not separately labeled) of axle 36 adjacent the driven wheel 34. A shaft seal 57 is located between the bearing 56 and the driven wheel 34. A rear brake assembly 58 is coupled to the end of axle 36 adjacent bearing 56. Rear brake assembly 58 is configured to selectively slow the rotation of the driven wheel 34 in response to an action by the operator, such as applying a brake pedal 60 or activating a parking brake 61. Of course, it should be understood that brake pedal 60 and parking brake 61 could be combined into a single actuator. Rear brake assembly 58 may be any known braking system used with vehicles, such as a caliper/rotor assembly. In the exemplary embodiment, rear brake assembly 58 may be connected to an electrically activated hydraulic system 63. In accordance with an aspect of an exemplary embodiment, hydraulic system 63 is mechanically and hydraulically isolated from the brake pedal 60 and parking brake 61. Hydraulic system 63 may be electrically driven by a separate electrical motor (not shown).

The vehicle 20 further includes a second set wheels, e.g. front wheels 64 arranged adjacent the engine 24. In one embodiment, the second set of wheels 64 may also be configured to receive output from the engine 24. This is sometimes referred to as a four-wheel or an all-wheel drive configuration. In this embodiment, the vehicle 20 may include a transfer case 65 that divides the output from the transmission 28 between the front and rear wheels 34, 64. Transfer case 65 transmits a portion of the output to a front differential assembly 66, which may include additional components (not shown) that transmit the output to driven wheels 34 through axles 68. Similar to the rear wheels 34, the front wheels 64 include a front brake assembly 70. Front brake assembly 70 is configured to selectively slow the rotation of the front wheels 64 in response to an action by the operator. In the exemplary embodiment, brakes 70 are also coupled to and actuated by the hydraulic system 63. As will be detailed more fully below, front and rear brake assemblies 70 and 58 are coupled to a non-hydraulic braking feedback controller 74 that may provide one or more of a tactile and an audible feedback to a driver depressing brake pedal 60 or parking brake 61.

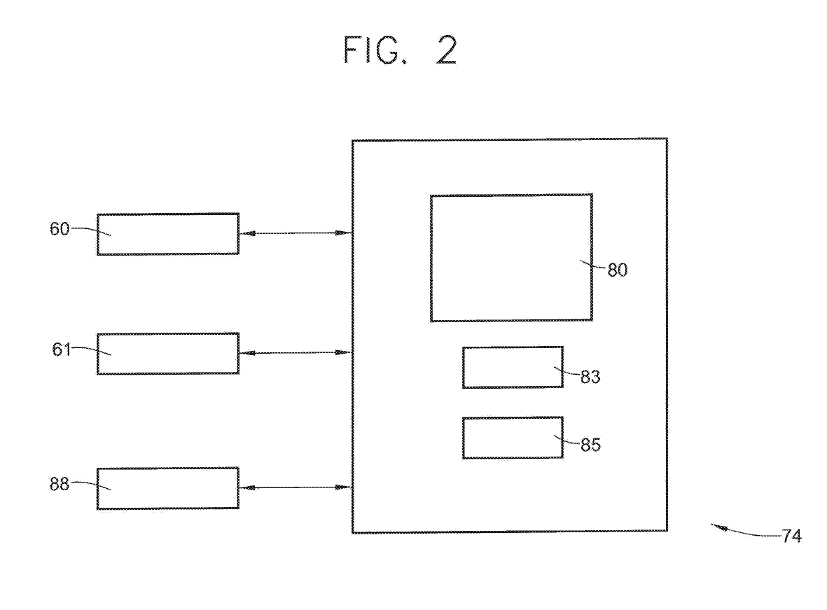

In accordance with an aspect of an exemplary embodiment illustrated in FIG. 2, non-hydraulic braking feedback controller 74 is operably connected to brake pedal 60 and parking brake 61. Non-hydraulic braking feedback controller 74 may include a central processing unit (CPU) 80, a feedback control module 83 and a memory module 85. Memory module 85 may have stored thereon a set of instructions or control logic that, when executed by CPU 80, provides one or more of a tactile feedback, an audible feedback, and visual feedback based on driver input and selected vehicle mode input through a mode selector switch 88.

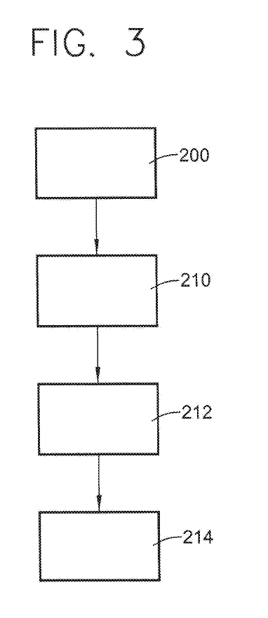

As shown on FIG. 3, non-hydraulic braking feedback controller 74 receives inputs from brake pedal 60 and/or parking brake 61 in block 200 as well as mode selector switch 88 in block 210. Based on those inputs, non-hydraulic braking feedback controller 74 processes various additional inputs from rear and front wheels 34 and 64, an accelerator (not shown), hydraulic system 63, brake pad wear indicators, ABS sensors, and the like in block 212 to determine one or more of an amplitude and/or a frequency of a tactile feedback, an audible feedback, and/or a visual feedback in block 214.

For example, in an ABS mode, non-hydraulic braking feedback controller 74 may adjust an amplitude and frequency of a tactile response, an audible response, and/or a visual indicator based on pressure applied to brake pedal 60, vehicle mode, and/or various sensors that may be associated with wheels 34 and 64, hydraulic system 63, ABS components, and the like. Higher pressure may result in a tactile and/or audible feedback having a higher amplitude and frequency. However, if also in a touring vehicle mode, the amplitude and frequency may be reduced relative to, for example, a sport mode, comfort mode, or a tow/haul mode. Non-hydraulic braking feedback controller 74 may dynamically adjust the amplitude and/or frequency of the feedback as pressure and/or wheel slippage changes. Similarly, when braking through a curve, non-hydraulic braking feedback controller 74 may execute a performance mode to dynamically adjust an amplitude and frequency of feedback provided to a driver based on inputs from one or more of rear and front wheels 34 and 64 as well as the position of mode selector switch 88 and/or various sensors that may be associated with wheels 34 and 64, hydraulic system 63, ABS components, and the like.

Non-hydraulic braking feedback controller 74 may also operate in a State of Health/Diagnostic/Day-to-Day driving mode in which feedback is provided to the driver based on one or more brake health conditions as sensed through brake pad sensors, pressure sensors, and the like, as well as other features. Other features could include parking brake position, hill hold assist mode activation/deactivation, and the like. Feedback could take the form of tactile, visual and/or audible feedback.

At this point, it should be understood that the exemplary embodiments describe a system for providing feedback to a driver operating a simulated brake pedal. Non-hydraulic feedback is provided based on driver inputs through the brake pedal and a selective vehicle operating mode. Further, the feedback may be based on various on-board sensors associated with the front and rear wheels, the brakes, and other components of the brake system. The feedback may be tactile, audible and/or visual. Feedback may be provided through the brake pedal, a haptic seat, a haptic steering wheel, speakers, and/or vehicle displays. Further, the amplitude and/or frequency of the feedback could be dynamically varied based on changes in driver inputs and vehicle conditions. Still further, feedback may be provided as a single perceptible experience, or combinations of perceptible experiences. Additionally, it should be understood that the sensors employed in providing inputs to the non-hydraulic braking feedback controller may vary depending upon vehicle type, make, model, and options.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A vehicle comprising: a chassis;
a power system supported by the chassis;
a plurality of wheels supported by the chassis, at least one of the plurality of wheels being operatively connected to the power system;
a plurality of brakes operatively associated with corresponding ones of the plurality of wheels;
a simulated brake pedal operatively associated with the plurality of brakes, the simulated brake pedal being hydraulically isolated from the plurality of brakes; and
a non-hydraulic braking feedback controller operatively connected to the plurality of brakes and the simulated brake pedal, the non-hydraulic braking feedback controller selectively providing at least one of a tactile feedback, an audible feedback, and a visual feedback to a driver based on an activation of the simulated brake pedal.

2. The vehicle according to claim 1, further comprising: a mode selector switch operatively coupled to the non-hydraulic braking feedback controller, the mode selector switch being operable to toggle the non-hydraulic braking feedback controller between a touring vehicle mode, a sport mode, a day-to-day driving mode, and a tow mode.

3. The vehicle according to claim 1, further comprising one or more brake pad sensors operatively coupled to the non-hydraulic braking feedback controller.

4. The vehicle according to claim 3, further comprising: an ABS sensor operatively connected to the non-hydraulic braking feedback controller.

5. The vehicle according to claim 4, wherein the non-hydraulic braking feedback controller selectively adjusts at least one of an amplitude and a frequency of the at least one of the tactile feedback, the audible feedback, and the visual feedback based on signals from one or more of the brake pad sensor and ABS sensor.

6. The vehicle according to claim 2, wherein the non-hydraulic braking feedback controller selectively adjusts at least one of an amplitude and a frequency of the at least one of the tactile feedback, the audible feedback, and the visual feedback based on a position of the mode selector switch.

7. The vehicle according to claim 1, further comprising: a parking brake, wherein the non-hydraulic braking feedback controller selectively providing the at least one of a tactile feedback, audible feedback, and visual feedback based on a position of the parking brake.

8. A method of providing at least one of a tactile and an audible feedback to a driver of a vehicle having a simulated brake pedal, the method comprising:
detecting an activation of the simulated brake pedal; determining an activation type; and
outputting one of a tactile feedback though the simulated brake pedal an audible feedback, and a visual feedback based on the activation type.

9. The method of claim 8, further comprising: determining an operating mode of the vehicle.

10. The method of claim 9, wherein determining the operating mode includes determining whether the vehicle is operating in one of a sport mode, a touring mode, a day-to-day driving mode and a tow mode.

11. The method of claim 10, further comprising: outputting one of the tactile feedback, the audible feedback, and the visual feedback based on the operating mode.

12. The method of claim 8, wherein outputting the one of the tactile and audible feedback includes selectively adjusting one of amplitude and a frequency of the one of the tactile feedback, the audible feedback, and the visual feedback based on the activation type.

13. The method of claim 8, wherein detecting the activation type includes receiving signals from one or more of a brake sensor, an ABS sensor, and a brake pad wear indicator sensor.

14. The method of claim 8, wherein detecting the activation type includes detecting deployment of a parking brake.

15. The method of claim 14, further comprising: activating a hill hold assist mode based on deployment of the parking brake.
